(19) United States
(12) Patent Application Publication
(10) Pub. No.: US 2011/0020632 A1
(43) Pub. Date: Jan. 27, 2011

(54) FOAMING MATERIAL WITH A FUNCTIONAL SURFACE

(76) Inventor: Li-Chi LIN, Pei Tou Hsiang (TW)

Correspondence Address: SINORICA, LLC, 2275 Research Blvd., Suite 500, ROCKVILLE, MD, 20850, US

(21) Appl. No.: 12/507,282

(22) Filed: Jul. 22, 2009

(51) Int. Cl. B32B 3/26

(52) U.S. Cl. 428/316.6; 428/304.4

(57) ABSTRACT

The present invention pertains to a foaming material with a functional surface comprising a foaming layer and a plurality of function layers disposed on a top surface, a bottom surface, or a peripheral surface of the foaming layer. Wherein, by means of the foaming layer disposed on the surfaces of the foaming layer, certain functions can be well performed and a greatly decreased manufacturing cost can be accordingly achieved.

### BACKGROUND OF THE INVENTION

1. Field of the Invention

The present invention relates to a foaming material with a functional surface.

2. Description of the Related Art

Referring to FIG. 1 shows a cross-sectional view of a conventional foaming body having mildewproof and antibacterial function. Wherein, the conventional foaming body 1 mainly consists of a Chinese herbaceous abstract having the mildewproof and antibacterial effect to be integrated with a plastic foaming material for foaming.

The foaming body 1 would preferably achieve a mildewproof and antibacterial effect. However, the mildewproof and antibacterial efficiencies only effect when they are distributed on the surface of the foaming body 1. As a result, the abstract within the inner layer of the foaming body 1 in fact would not result in any function, and the manufacturing cost is accordingly increased, which therefore indeed needs to be improved.

### SUMMARY OF THE INVENTION

It is an object of the present invention to provide a foaming material with a functional surface comprising a foaming plate and a plurality of function plates disposed on a top surface, a bottom surface, or a peripheral surface of the foaming plate.

The foaming plate in conformity with the present invention distributed on the surface of the foaming plate brings a result with a certain function, which more decreases the manufacturing cost thereof.

### BRIEF DESCRIPTION OF THE DRAWINGS

FIG. 1 is a cross-sectional view showing a conventional foaming body having a mildewproof and antibacterial function;

FIG. 2 is a schematic view showing a first preferred embodiment before being foamed and combined;

FIG. 3 is a perspective view showing the present invention after being integrally foamed and combined; and

FIG. 4 is a cross-sectional view of FIG. 3.

### DETAILED DESCRIPTION OF THE PREFERRED EMBODIMENTS

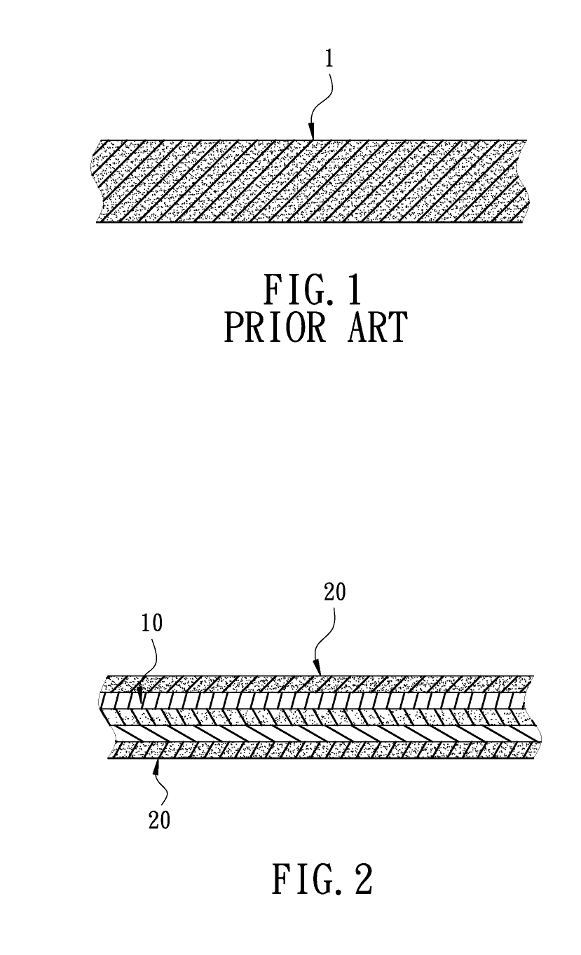

Referring to FIG. 2 showing a first preferred embodiment of the present invention before foaming and combining, a plurality of foaming materials 10 are piled with each other to adjust to an appropriate thickness thereof. After the foaming materials 10 finish piling, a function material 20 further respectively disposes on a top surface and a bottom surface of the foaming materials 10, so that the foaming materials 10 and the function material 20 would be put into a foaming molding die (not shown). Wherein, the foaming materials 10 adopt Ethylene Vinyl Acetate, EVA, and the function material 20 contains antibacterial elements, anti-electromagnetic wave elements, anti-slip elements, anti-UV elements, or anti-mildew elements, respectively.

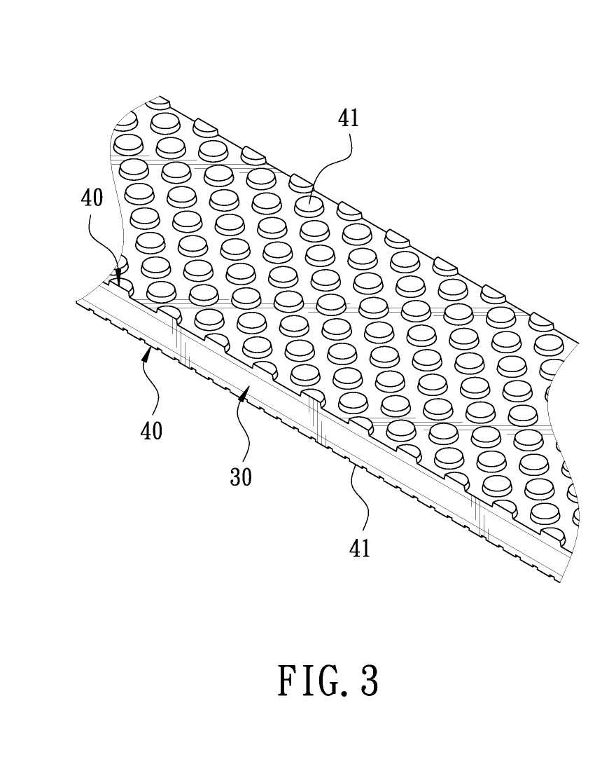

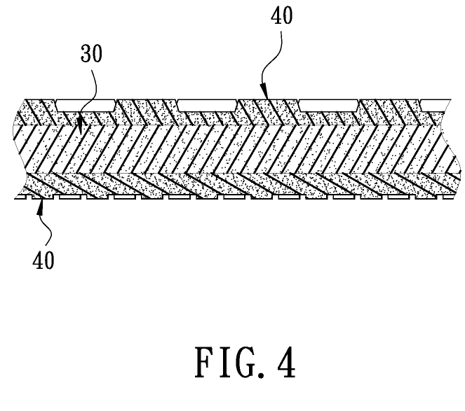

Further referring to FIGS. 3 and 4 show a perspective view and a cross-sectional view of the integrally foamed and combined present invention, respectively. The foaming material 10 and the function material 20 utilize the foaming molding die to integrally foam and combine, resulting in the developments of the following structures:

A foaming plate 30 foamed by the foaming material 10 forms a plate body thereof.

A plurality of function layers 40 is formed by the foaming function material 20. Wherein, the function layers 40 are integrally foamed to combine with the top surface and the bottom surface of the foaming layer 30. Moreover, the function layer 40 in this embodiment is directed to an antibacterial layer, an anti-electromagnetic wave layer, an anti-slip layer, an anti-UV layer, or an anti-mildew layer, so that the function layer 40 would achieve an efficiency of anti-bacteria, anti-electromagnetic wave, anti-slip, anti-UV, or anti-mildew. Further, a plurality of protrusions 41 are formed by the foaming molding die to be distributed on the function layers 40 at the opposite two sides of the foaming layer 30, respectively. Thus, an esthetic appearance of the finishing product conforming to the present invention can be achieved.

Alternatively, a second preferred embodiment of the present invention employs the function material 20 containing a plurality of functional elements selected from antibacterial elements, anti-electromagnetic wave elements, anti-slip elements, anti-UV elements, anti-mildew elements, and a combination of the elements above. Therefore, the corresponding foamed function layer 40 would possess a multiple functions.

Further referring to FIG. 4, apparently, the function layers 40 are disposed on the superficial two sides of the foaming layer 30, respectively. As a result, during operation, users in fact directly contact the function layers 40, which previously perform the aforementioned functions. Further, since the function layer 40 is only disposed on the superficial surface of the foaming layer 30, no other unnecessary element is contained in the foaming layer 30. Thus, the manufacturing cost of the present invention is accordingly decreased.

While the preferred embodiment of the invention has been described above, it will be recognized and understood that various modifications may be made therein and the appended claims are intended to cover all such modifications that may fall within the spirit and scope of the invention.

I claim:

1. A foaming material with a functional surface comprising:
a foaming plate foamed by at least one foaming material; and
at least one function plate distributing over a top surface, a bottom surface, or a peripheral surface of said foaming plate.

2. The foaming material as claimed in claim 1, wherein, said foaming plate and said function plate are integrally foamed to combine together.

3. The foaming material as claimed in claim 1, wherein, said foaming material adopts Ethylene Vinyl Acetate, EVA.

4. The foaming material as claimed in claim 1, wherein, said foaming plate is formed by a foamed function material.

5. The foaming material as claimed in claim 4, wherein, said function plate adopts an antibacterial layer, and said function material contains antibacterial elements.

6. The foaming material as claimed in claim 4, wherein, said function plate adopts an anti-electromagnetic wave layer, and said function material contains anti-electromagnetic wave elements.

7. The foaming material as claimed in claim 4, wherein, said function plate adopts an anti-slip layer, and said function material contains anti-slip elements.

8. The foaming material as claimed in claim 4, wherein, said function plate adopts an anti-UV layer, and said function material contains anti-UV elements.

9. The foaming material as claimed in claim 4, wherein, said function plate adopts a mildewproof layer, and said function material contains anti-mildew elements.

10. The foaming material as claimed in claim 4, wherein, said function material contains at least two kinds of elements selected from antibacterial elements, anti-electromagnetic wave elements, anti-slip elements, anti-UV elements, anti-mildew elements, and a combination of said elements.

11. The foaming material as claimed in claim 1, wherein, said foaming plate is formed by a plurality of foamed foaming material, and said foaming material adopts chemical polyester.
